(19) United States
(12) Patent Application Publication
(10) Pub. No.: US 2024/0261612 A1
(43) Pub. Date: Aug. 8, 2024

(54) FIRE EXTINGUISHING SYSTEM

(71) Applicant: EGIDUS SAFETY AB, Norrköping (SE)

(72) Inventors: Monica JANGLAND, Norrköping (SE); Håkan JANGLAND, Norrköping (SE); Karin SVEDMAN, Norrköping (SE); Tobias SVEDMAN, Norrköping (SE)

(21) Appl. No.: 18/566,406

(22) PCT Filed: Jun. 1, 2022
(86) PCT No.: PCT/SE2022/050526

§ 371 Date: Dec. 1, 2023

(30) Foreign Application Priority Data
Jun. 2, 2021 (SE) 2150703-3

(51) Int. Cl. A62C 13/76; A62C 37/08; A62C 37/36

(52) U.S. Cl. CPC A62C 13/76; A62C 37/08; A62C 37/36

(57) ABSTRACT

Fire extinguishing system (1) comprising a fire extinguisher (2) provided with a handle (5) configured such that upon activation thereof fire extinguishing substance is discharged through an outlet (4) of the fire extinguisher (2). A safety mechanism (6), which when in a first state, is arranged to prevent manual activation of the handle and when in a second state is arranged to allow manual activation of the handle. A control module (7) comprising a communication unit (8) and an actuator (9), wherein the actuator (9) is connected to the safety mechanism (6), and when the communication unit (8) receives a an activation signal the communication unit (8) is arranged to activate the actuator (9), wherein the actuator (9) causes the safety mechanism (6) to change from its first state into its second state and further causes fire extinguishing substance to discharge through the outlet (4) of the fire extinguisher (2).

### TECHNICAL FIELD

The present invention relates to an automatic fire extinguishing system comprising a hand-held fire-extinguisher.

### BACKGROUND

In 2017 the rescue service in Sweden received just over 28,000 alarms caused by fire, of which about 10,000 alarms refer to fires in buildings. Statistics from 2017 show that Swedish insurance companies paid out approximately SEK 6 billion in insurance compensation for damages caused by fire. Sweden has a zero vision, which means that no one should have to die or be seriously injured due to fire. Still, about 100 people die annually in fires and about three times as many are injured so severely that they need to be hospitalized.

You cannot completely protect yourself from a fire, but you can limit the damage of a fire. A fire takes time to develop, which means that there is room for action for those who are capable of acting. There is a great need to be able to improve opportunities for early intervention in the event of a fire. In the event of a fire, proximity to a fire brigade is often crucial. The response time to fires outside the urban area is relatively long compared to in urban areas. Residents in rural areas may therefore need to take extra measures to be able to prevent and extinguish fires.

If there is a fire extinguisher in the house, the chance increases that a fire can be extinguished early. The faster a fire is extinguished, the less damage there will be, and the risk that the fire grows decreases. The purpose of the hand-held fire extinguisher is to be able to influence a fire early and limit the damage. The disadvantage is that you need to be in place when the fire occurs to be able to use it. Even though you are at home, you may not have the opportunity to physically affect the fire due to, for example, disabilities or other limited ability to act.

There is, hence, a need to start firefighting work as early as possible and to be able to do this despite being at a distance from the closest fire brigade.

### SUMMARY OF THE INVENTION

It is an object of the present disclosure to provide a fire extinguishing system comprising a fire extinguisher, such as a hand-held fire extinguisher, wherein the fire extinguishing system upon receipt of an activation signal automatically discharges a fire extinguishing substance at a fire. Thereby, firefighting work can be started even though no one is at home to manually use the fire extinguisher.

The invention is defined by the appended independent claims. Non-limiting embodiments emerge from the dependent claims, the appended drawings and the following description.

According to a first aspect, there is provided a fire extinguishing system comprising a fire extinguisher comprising a container arranged to contain an agent that upon discharge through an outlet of the fire extinguisher forms a fire extinguishing substance suitable for extinguishing a fire. The fire extinguisher further comprises a handle configured such that upon activation thereof, fire extinguishing substance is discharged through the outlet of the fire extinguisher, and a safety mechanism, which when in a first state is arranged to prevent manual activation of the handle and when in a second state is arranged to allow manual activation of the handle. The fire extinguishing system further comprises a control module, which control module comprises a communication unit and an actuator, wherein the actuator is connected to the safety mechanism, wherein when the communication unit receives an activation signal the communication unit is arranged to activate the actuator, wherein the activated actuator causes the safety mechanism to change from its first state into its second state, and when the safety mechanism is in the second state the activated actuator further actuates the handle, thereby causing fire extinguishing substance to be discharged through the outlet of the fire extinguisher.

The fire extinguishing system may be a hand-held fire extinguishing system for use at home, such as in the kitchen, in terraced house attics etc. It can be used in offices, in industrial premises, ware house buildings, stables, barns, garages etc. The fire extinguishing system can also be used in rooms where other fire-fighting equipment is not optimal for various reasons.

The handle is configured such that upon manual activation thereof, fire extinguishing substance is discharged through the outlet of the fire extinguisher. Manual activation of the handle may take place through pressing, squeezing, compressing, lifting etc. the handle.

The safety mechanism can manually be changed into its second state. Thereby, the handle may be manually activated and fire extinguishing formula expelled.

The control module may be arranged at the fire extinguisher and possibly fixed to the fire extinguisher. The communication unit of the control module may, alternatively, be arranged at a distance from the fire extinguisher.

When the communication unit receives an activation signal, the communication unit is arranged to activate the actuator, wherein the activated actuator causes the safety mechanism to change into its second state. When the safety mechanism is in the second state the activated actuator further actuates the handle, thereby causing fire extinguishing substance to be discharged through the outlet of the fire extinguisher. To cause the fire extinguishing substance to be discharged, the activated actuator may act on the handle such that the handle is e.g. compressed, pressed, squeezed or lifted and thereby, the fire extinguishing substance is discharged through the outlet. Alternatively, the actuator causes fire extinguishing formula to be discharged without activation of the handle, e.g. through opening of a vent mechanism.

That the communication unit receives an activation signal is here and henceforth meant that the communication unit receives at least one activation signal or two or more (different) activation signals. From a security perspective, it could be an advantage if the communication unit only is activated upon receipt of two or more activation signals, such that the fire extinguishing system is not activated by mistake.

The described fire extinguishing system may comprise a normal state of the art/standard fire extinguisher, such as a hand-held fire extinguisher. The present system is a further development of, or add-on to such existing hand-held fire extinguishers and their basic function. The fire extinguisher of the system can be used manually, where a person can activate the extinguisher on site by removing the safety pin and activating the handle by for example pressing it. At the same time, the present fire extinguishing system is an automatic system. It can be activated by sending an activation signal to the communication unit of the control module. In response to this activation signal, the safety mechanism is automatically changed to/put in its second state and fire extinguishing substance automatically discharged. No manual switch of the safety mechanism from the first state to the second state or manual activation of the handle is needed. Due to this duality, it is not necessary to have several different fire tools to be able to effectively prevent the spread of fire.

By means of the present system, fires may be extinguished, or at least kept under control until firefighters have reached the fire.

The activation signal may be sent to the fire extinguishing system from for example a monitoring system comprising smoke detectors. The activation signal may, alternatively or in addition, be sent to the fire extinguishing system as a manual remote trigger from a user having been notified that there is a fire in the vicinity of the fire extinguishing system. In both cases, no person needs to be physically present and yet, a firefighting operation can be started and thus reduce the consequences of a fire. The present fire extinguishing system therefore relates to enabling hand fire extinguishers to act automatically or remotely in the event of a fire. Thereby, a natural person does not need to be nearby when a fire occurs.

Other products on the market that offer solutions with automatic fire extinguishing, such as sprinklers, are often costly installations that are not an option for, for example, private homes. The present fire extinguishing system is a cheaper solution compared to for example sprinkler systems.

The actuator may comprise a spring, wherein when the spring is in an extended state the safety mechanism is in the first state, and when the communication unit receives an activation signal and activates the actuator, the spring is caused into a compressed state whereby the safety mechanism is changed into its second state.

The fire extinguishing system may further comprise a handle activator connected between the actuator and the handle, wherein when the activated actuator causes the safety mechanism to change from its first state into its second state, and when the safety mechanism is in the second state, the handle is activated by said handle activator such that fire extinguishing substance is discharged through the outlet of the fire extinguisher.

The handle activator may be connected to the handle in such a way that the handle is pressed/compressed/squeezed/lifted upon activation of the actuator.

In one embodiment, such handle activation may be caused by compression of the above described spring.

The safety mechanism may be connected to the actuator through a safety mechanism wire and the handle activator may be connected to the actuator through a handle activation wire, wherein upon activation of the actuator, the safety mechanism wire and the handle activator wire are both pulled by the spring being compressed, such that the safety mechanisms is changed from its first state to its second state and the handle activator is caused to act on the handle such that fire extinguishing substance is discharged through the outlet of the fire extinguisher.

The safety mechanism wire and the handle activation wire may be arranged such that upon compression of the spring, the safety mechanism is changed into its second state before the handle activator is caused to act on the handle. Otherwise, the handle activator will not be able to activate the handle. This could for example be accomplished by having wires of different lengths.

The handle activator wire may be pulled by the compression of the spring.

The safety mechanism may comprise a safety pin, wherein when at least a portion of the safety pin is inserted into or above/below the handle, the safety mechanism is in the first state, and when the safety pin is removed from the handle or from above/below the handle, the safety mechanism is in the second state.

As discussed above, the safety mechanism can be changed into its second state manually, i.e. the safety pin is pulled out/removed manually. Alternatively, the safety mechanism, can automatically be changed into the second state, i.e. the safety pin is pulled out/removed through activation of the actuator.

The communication unit may be arranged to receive an activation signal via a wireless signal.

The activation signal may be at least one activation signal or two or more (different) activation signals. From a security perspective, it could be an advantage if the communication unit only is activated upon receipt of two or more activation signals, such that the fire extinguishing system is not activated by mistake.

The wireless signal may for example be via Wifi, mobile networks, e.g. 3G, 4G, 5G, or combinations thereof. The signal may alternatively, or in addition, be a signal from a fire detector and/or smoke detector in the room, a nearby room or anywhere in the house or building wherein the fire extinguishing system is located. The signal may be sent from a distance from the fire extinguishing system, such as from another part of the room, another part of the house, another part of the city, another part of the country or even from abroad. The communication unit can be activated through a mobile app. For example, the owner of a house can receive a message from the fire/smoke detection system that there is a fire in the house, whereupon the owner sends a message to the communication module to activate the fire extinguishing system to start extinguishing the fire. Alternatively, or in addition, the owner of a house can receive a message from the fire detection system that there is a fire in the house, and that the fire extinguishing system has been/will be activated to start extinguishing the fire.

Advantageously, the fire extinguishing system can be used in the smart home and connected to other alarm equipment and monitoring systems.

The fire extinguishing system may further comprise a camera arranged at the fire extinguisher.

The camera may for example be used to remotely verify that there is an actual fire before the fire extinguisher is activated and fire extinguishing substance is discharged.

The extinguishing operation started can be controlled by monitoring the proceedings via the camera.

The communication unit may, upon receiving a deactivation signal, be arranged to deactivate the actuator, wherein the actuator stops substance from being discharged through the outlet of the fire extinguisher.

The deactivation signal may be based on images from the camera. If the fire seems extinct, it is not necessary to fully empty the container. Thereby, work with cleaning up after the fire has been made extinct can be limited. The emptying can also be started again if the fire should flare up again, which is then visible though the camera.

Upon deactivation of the actuator, the spring may be relaxed and thereby the handle activator is caused to no longer act on the handle, why fire extinguishing substance is no longer discharged through the outlet of the fire extinguisher.

The deactivation signal may move the spring into a relaxed state, such that the handle activation wire is relaxed and no handle activation takes place.

The fire extinguishing system may be provided with one or more wheels such that the fire extinguishing system is moveable along the floor of a space in which the fire extinguishing system is provided.

By providing the fire extinguishing system with wheels, the fire extinguishing system may upon activation be moved closer to a fire, based on camera view, temperature measurements etc. The fire extinguishing system may move automatically closer to a fire upon activation or be controlled to move in the room/space by using the view from the camera.

### BRIEF DESCRIPTION OF THE DRAWINGS

FIG. 1 shows a fire extinguishing system comprising a hand-held fire extinguisher and a control module.

FIG. 2 shows an upper portion of the fire extinguishing system in FIG. 1.

FIG. 3 shows the fire extinguishing system of FIG. 1 wherein the safety mechanism has been removed.

FIG. 4 shows an embodiment of the safety mechanism in more detail.

FIG. 5 shows the safety mechanism of FIG. 4 in an exploded view.

FIG. 6 shows the fire extinguishing system provided with a camera unit and wheels.

### DETAILED DESCRIPTION

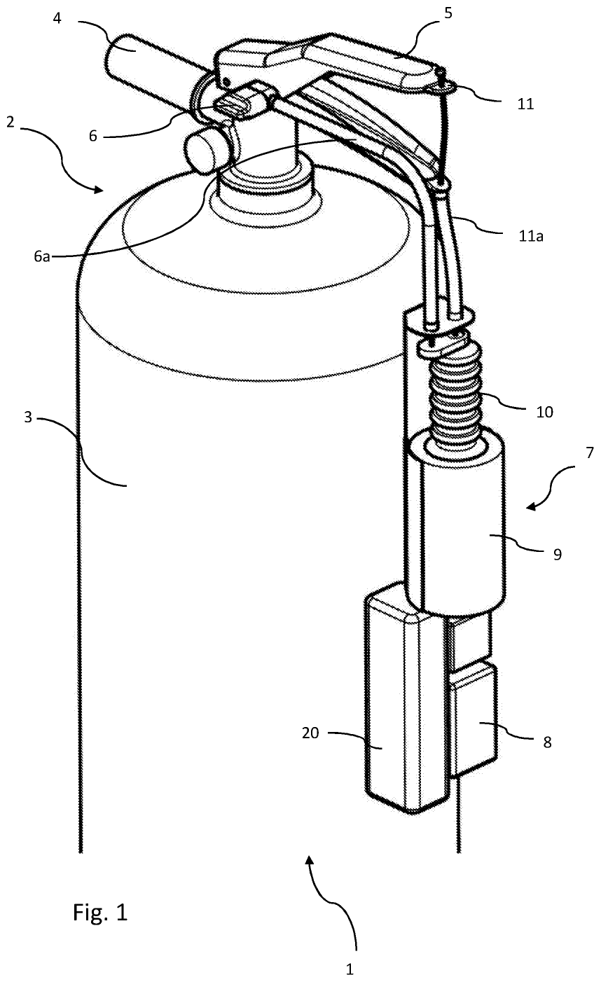

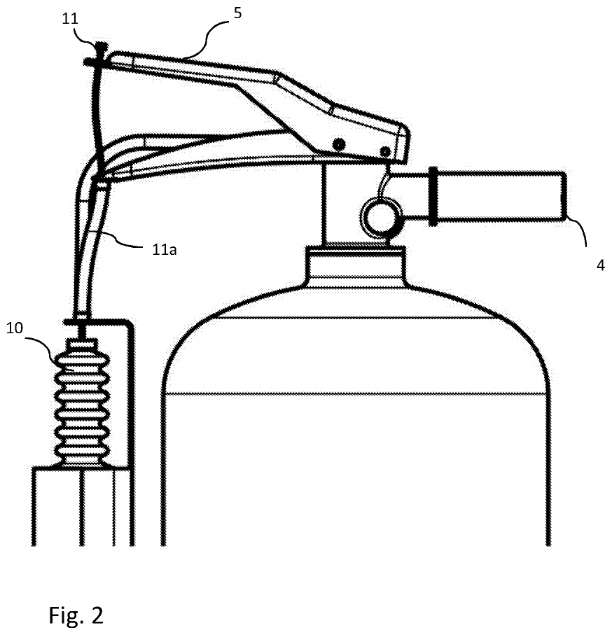

In FIG. 1 and FIG. 2 is shown a fire extinguishing system 1 comprising a standard hand-held fire extinguisher 2. The fire extinguisher 2 comprises a container 3, which may be a cylinder as illustrated in the figures, arranged to contain an agent that upon discharge through an outlet 4 of the fire extinguisher forms a fire extinguishing substance suitable for extinguishing a fire. To the outlet 4 of the fire extinguisher 2 may be connected a nozzle and/or a hose. The fire extinguisher 2 may for example be a powder extinguisher. The content of powder extinguishers has an “outreach” function, i.e. the powder works actively to seek its way to the hearth. Therefore, it is not necessary to aim exactly at the area where the fire starts with the fire extinguishing substance to still have an effect that delays the course of a fire.

The fire extinguisher has a handle 5, which is configured such that upon activation thereof, fire extinguishing substance is discharged through the outlet 4 of the fire extinguisher 2.

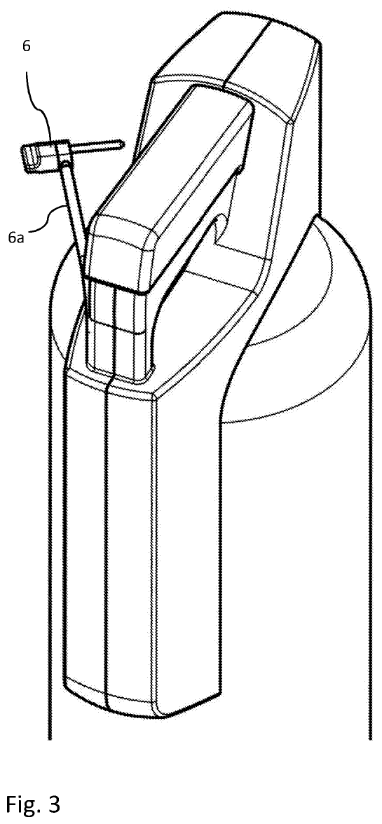

There is also a safety mechanism 6. When the safety mechanism is in a first state (as illustrated in FIG. 1), locked position, the safety mechanism 6 prevents manual activation, e.g. pressing, squeezing etc., of the handle 5. When the safety mechanism 6 is changed into a second state, e.g. removed, as shown in FIG. 3, the handle 5 can be manually activated, which causes fire extinguishing substance to be discharged through the outlet 4 of the fire extinguisher 2.

The safety mechanism 6 may comprise a switch, knob, wheel or the like, which can be moved between at least two different positions/states, a second state/position wherein the handle can be activated and a first state/position wherein the handle is prevented from being activated. The safety mechanism 6 may, alternatively, comprise a safety pin 116 as illustrated in FIGS. 3, 4 and 5. At least a portion of the safety pin 116 may be inserted into or above/below the handle 5, as illustrated in FIGS. 1 and 2. In this position the safety pin 116 and the safety mechanism 6 is in its first state and manual or automatic activation of the handle 5 is not possible. When the safety pin 116 is removed from the handle 5 or from above/below the handle, the safety mechanism 6 is in the second state and manual or automatic activation of the handle 5 is possible.

The fire extinguishing system 1 further comprises a control module 7, which comprises a communication unit 8 and an actuator 9. The actuator 9 is connected to the safety mechanism 6. When the communication unit 8 receives an activation signal the communication unit 8 is arranged to activate the actuator 9, wherein the activated actuator 9 causes the safety mechanism 6 to change from its first position into its second position. When the safety mechanism is in the second state the activated actuator 9 further actuates the handle 5, thereby causing fire extinguishing substance to be discharged through the outlet 4 of the fire extinguisher 2.

That the communication unit receives an activation signal is meant that the communication unit receives at least one activation signal or two or more (different) activation signals. From a security perspective, it could be an advantage if the communication unit only is activated upon receipt of two or more activation signals, such that the fire extinguishing system is not activated by mistake.

As illustrated in FIGS. 1 and 2, the actuator 9 may comprise a spring 10. When the spring 10 is in an extended/relaxed state the safety mechanism 6 is in the first state (as shown in FIGS. 1 and 2). When the communication unit 8 receives an activation signal and activates the actuator 9, the spring 10 is caused into a compressed state and the safety mechanism 6 is caused to change from its first state to its second state, as illustrated in FIG. 3.

The fire extinguishing system 1 may have a handle activator 11 connected to the actuator 9 and to the handle 5. When the activated actuator 9 causes the safety mechanism 6 to change from its first state into its second state, and when the safety mechanism is in the second state, the handle 5 is activated by the handle activator 11 such that fire extinguishing substance is discharged through the outlet 4 of the fire extinguisher 2.

The safety mechanism 6 may be connected to the actuator 9 through a safety mechanism wire 6a and the handle activator 11 may be connected to the actuator 9 through a handle activation wire 11a. Upon activation of the actuator 9, the safety mechanism wire 6a and the handle activator wire 11a are both pulled by the spring 10 upon compression thereof, such that the safety mechanism 6 is changed from its first state into its second state and the handle activator 11 is caused to act on the handle 5, such that fire extinguishing substance is discharged through the outlet 4 of the fire extinguisher 2.

As discussed above, the safety mechanism 6 can be changed into its second state manually, e.g. the safety pin 116 may be pulled out/removed manually. Alternatively, the safety mechanism 6, can automatically be changed into the second state, e.g. the safety pin 116 may be pulled out/removed through activation of the actuator 9.

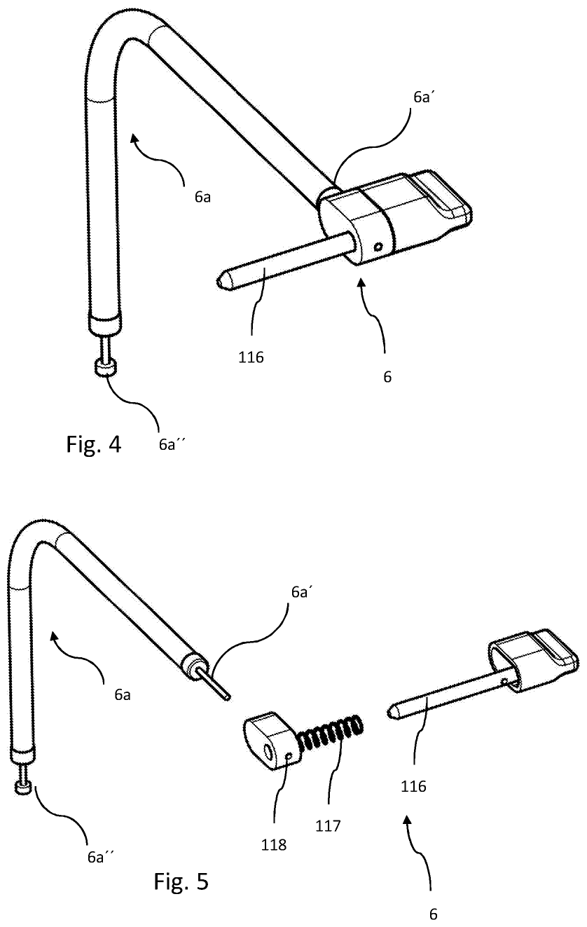

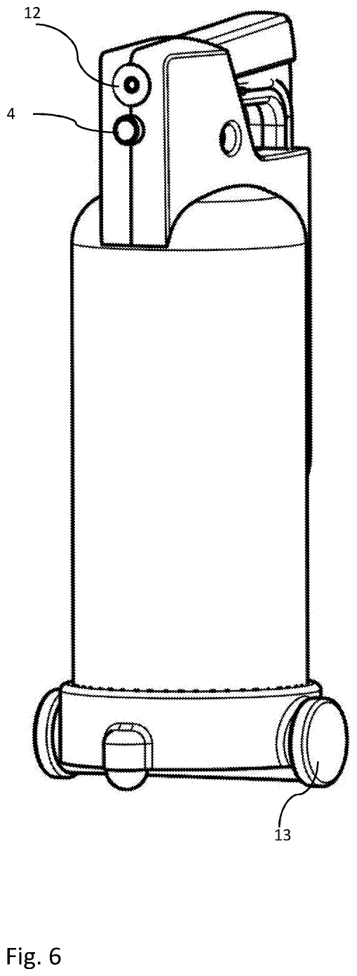

In FIGS. 4 and 5 is shown one embodiment of the safety mechanism 6 comprising a safety pin 116 as discussed above. The safety mechanism 6 is connected to the actuator by the safety mechanism wire 6a. The wire 6a has a first end 6a′ for connection to the safety mechanism 6 and a second end 6a″ for connection to the actuator 9. The safety mechanism 6 may comprise a safety pin 116 and a safety spring 117. The first end 6a′ of the safety mechanism wire 6a may be provided with a locking pin (as shown in FIG. 5). When at least a portion of the safety pin 116 of the safety mechanism 6 is inserted through the safety spring 117, to form an assembled safety mechanism 6, the locking pin at the first end 6a′ of the safety mechanism wire 6 may be inserted through a hole 118 in the safety mechanism 6, such that the locking pin holds the safety spring 117 and the safety pin 116 of the safety mechanism 6 together/assembled with the safety spring 117 in a compressed state. Upon manual removal/manipulation of the safety mechanism 6 the safety mechanism is pulled such that the safety pin 116 is removed from the handle 5 or from a position above/below the handle.

When the actuator 9 is activated, the safety mechanism wire 6a is pulled by the spring 10 upon compression thereof. Thereby, the locking pin at the first end 6a′ of the safety mechanism wire 6a is pulled back from the hole 118 in the safety mechanism 6 and the safety spring 117 and the safety pin 116 becomes separated. The compressed safety spring 117 becomes relaxed and through this change of state (i.e. from compressed to relaxed state) the safety pin 116 and the safety spring 117 become disassembled and the safety pin 116 “jumps” out of its position in the handle 5 or from a position above/below the handle 5. Thereby the safety mechanism 6 has been caused to change into its second state and the handle activator 11 can to act on the handle 5, such that fire extinguishing substance is discharged through the outlet 4 of the fire extinguisher 2.

The communication unit 8 may be arranged to receive an activation signal via a wireless signal, such as via Wifi, mobile networks, e.g. 3G, 4G, 5G, or combinations thereof. The signal may be alternatively, or in addition, be a signal from a fire detector or smoke detector or from a person, e.g. through a mobile app, which has been notified that there is a fire.

The fire extinguishing system 1 may comprise a camera 12, as shown in FIG. 6. The camera 12 may for example be used to remotely verify that there is an actual fire before the fire extinguishing substance is discharged. Further, the extinguishing operation can be controlled by monitoring the proceedings via the camera.

The communication unit may, upon receiving a deactivation signal, be arranged to deactivate the actuator 9, wherein the actuator stops acting on the handle and thereby stops substance from being discharged through the outlet 4 of the fire extinguisher 2.

Upon deactivation of the actuator 9, the spring 10 may be relaxed and thereby the handle activator 11 no longer acts on the handle 5, why fire extinguishing substance is no longer discharged through the outlet 4 of the fire extinguisher 2.

As shown in FIG. 6, the fire extinguishing system 1 may be provided with one or more wheels 13 such that the fire extinguisher system 1 is moveable along the floor of a space in which the fire extinguishing system is provided. The fire extinguishing system may be provided with one wheel and a gyro, or two wheels or three wheel, or four wheels.

The fire extinguishing system 1 may be provided with an energy source 20, such as a battery. The energy source 20 may provide the communication unit 7 with energy such that it can receive signals and act on received signals. The same energy source 20 may be used for energizing the communication unit and the actuator 9. Alternatively, different energy sources may be used for the energizing the communication unit and the actuator.

In one embodiment the actuator 9 may be activated when the communication unit 8 sends a signal to a relay 21 to open, such that energy from an energy source 20 reaches the actuator 9 and spring 10, thereby the actuator is activated and the spring 10 compressed.

The above-described fire extinguishing system 1 may be used manually as a standard hand-held fire extinguisher. Due to the control module 7, the same fire extinguishing system 1 can be used automatically/can be remotely controlled without the need of a person being physically present, and a firefighting operation can be started and thus reduce the consequences of a fire.

1-10. (canceled)

11. Fire extinguishing system comprising:
a fire extinguisher comprising:
an outlet,
a container, which is arranged to contain an agent that upon discharge through said outlet forms a fire extinguishing substance suitable for extinguishing a fire,
a handle, configured such that upon activation thereof fire extinguishing substance is discharged through the outlet of the fire extinguisher, and
a safety mechanism with two states, wherein when the safety mechanism is in a first state manual activation of said handle is prevented and when in a second state manual activation of said handle is allowed, and
a control module comprising a communication unit and an actuator,
wherein:
the actuator is connected to the safety mechanism,
the communication unit upon receipt of an activation signal is configured to activate the actuator, and
the activated actuator is configured to cause the safety mechanism to change from its first state into its second state and to thereafter actuate the handle, thereby causing fire extinguishing substance to be discharged through the outlet of the fire extinguisher.

12. The fire extinguishing system of claim 11, wherein the actuator comprises a spring, wherein when the spring is in an extended state the safety mechanism is arranged in the first state, and when the spring is caused into a compressed state the safety mechanism is arranged to change into its second state.

13. The fire extinguishing system of claim 11, further comprising a handle activator connected between the actuator and the handle, wherein when an activated actuator has caused the safety mechanism to change from its first state into its second state the handle is arranged to be activated by said handle activator, such that fire extinguishing substance is discharged through the outlet of the fire extinguisher.

14. The fire extinguishing system of claim 12, wherein the safety mechanism is connected to the actuator through a safety mechanism wire and the handle activator is connected to the actuator through a handle activation wire, wherein upon activation of the actuator the safety mechanism wire and the handle activator wire are both arranged to be pulled by the spring being compressed, such that the safety mechanism is changed from its first state to its second state and the handle activator is caused to act on the handle such that fire extinguishing substance is discharged through the outlet of the fire extinguisher.

15. The fire extinguishing system of claim 13, wherein the safety mechanism is connected to the actuator through a safety mechanism wire and the handle activator is connected to the actuator through a handle activation wire, wherein upon activation of the actuator the safety mechanism wire and the handle activator wire are both arranged to be pulled by the spring being compressed, such that the safety mechanism is changed from its first state to its second state and the handle activator is caused to act on the handle such that fire extinguishing substance is discharged through the outlet of the fire extinguisher.

16. The fire extinguishing system of claim 11, wherein the safety mechanism comprises a safety pin, wherein when at least a portion of the safety pin is inserted into or above/below the handle, the safety mechanism is arranged to be in the first state, and when said safety pin is removed from the handle or from above/below the handle the safety mechanism is arranged to be in the second state.

17. The fire extinguishing system claim 11, wherein the communication unit is arranged to receive an activation signal via a wireless signal.

18. The fire extinguishing system of claim 11, further comprising a camera arranged at the fire extinguisher.

19. The fire extinguishing system of claim 11, wherein the communication unit, upon receiving a deactivation signal, is arranged to deactivate the actuator, wherein the actuator is arranged to stop substance from being discharged through the outlet of the fire extinguisher.

20. The fire extinguishing system of claim 11, wherein the fire extinguisher system is provided with one or more wheels such that the fire extinguisher system is moveable along the floor of a space in which the fire extinguishing system is provided.
